(19) United States
(12) Patent Application Publication
(10) Pub. No.: US 2008/0134495 A1
(43) Pub. Date: Jun. 12, 2008

(54) METHOD FOR MANUFACTURING METAL SEPARATOR FOR FUEL CELL

(76) Inventor: Dae Hyeon Joung, Yongin (KR)

Correspondence Address: MORGAN, LEWIS & BOCKIUS LLP (SF), One Market, Spear Street Tower, Suite 2800, San Francisco, CA, 94105, US

(21) Appl. No.: 11/837,409

(22) Filed: Aug. 10, 2007

(30) Foreign Application Priority Data
Dec. 7, 2006 (KR) 10-2006-0123700

(51) Int. Cl. H01M 8/02

(52) U.S. Cl. 29/623.2

(57) ABSTRACT

A method of manufacturing a metal separator for a fuel cell includes molding first and second plates such that each plate has at least one concave portion and at least one convex portion; applying a sealant to at least one of the plates; placing the plates such that the concave portions of each plate are opposite the convex portions of the other plate, and the ends of the second plate protrude beyond the ends of the first plate; and seaming the ends of the first plate to the ends of the second plate. The seaming may include bending the ends of the plates at right angles with a conical roller, bending the ends of the second plate to surround the ends of the first plate with the conical roller, and bending the ends of the plates at right angles with a cylindrical roller.

### CROSS-REFERENCE TO RELATED APPLICATION

This application claims the benefit under U.S.C. §119(a) of Korean Patent Application No. 10-2006-0123700, filed on Dec. 7, 2006, the entire contents of which are incorporated herein by reference.

### BACKGROUND OF THE INVENTION

1. Field of the Invention

The present invention relates to a method of manufacturing a metal separator for a fuel cell.

2. Description of Related Art

In portable electronic devices, such as cellular phones, two-way radios, and notebook computers, a small-scale fuel cell stack may be a proper alternative power source, replacing batteries. In addition to being pollution-free, fuel cell stacks provide increased convenience in not needing to be recharged.

To manufacture a fuel cell stack, membrane electrode assemblies (MEAs) are layered with interposing separators therebetween. The separators uniformly supply hydrogen and oxygen to the MEAs, and electrically connect the MEAs in series.

The separators are usually made of graphite. However, the cost and time associated with machining graphite are high.

Metal separators have also recently been used. A metal separator includes flow paths for supplying hydrogen, oxygen, and coolant, and supports the MEA. If airtightness is not maintained, the coolant may leak to contaminate the MEA, rendering the contaminated cell useless. In addition, there is a possibility of fire if hydrogen leaks.

In order to maintain the airtightness, a rubber seal is inserted into both ends of upper and lower plates, thus maintaining the airtightness of the metal separator and connecting the upper and lower plates to each other using an adhesive force of the rubber seal. The plates are sealed and bonded manually.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In an exemplary embodiment, a method of manufacturing a metal separator for a fuel cell includes molding first and second plates such that each plate has at least one concave portion and at least one convex portion; applying a sealant to at least one of the plates; placing the plates such that the concave portions of each plate are opposite the convex portions of the other plate, and the ends of the second plate protrude beyond the ends of the first plate; and seaming the ends of the first plate to the ends of the second plate.

The seaming may include bending the ends of the plates at right angles with a conical roller, bending the ends of the second plate to surround the ends of the first plate with the conical roller, and bending the ends of the plates at right angles with a cylindrical roller.

### BRIEF DESCRIPTION OF THE DRAWINGS

The above and other features of the present invention will be described with reference to certain exemplary embodiments thereof illustrated the attached drawings in which:

FIG. 1 is a schematic diagram of a bonding order of a metal separator for a fuel cell in accordance with an embodiment of the present invention.

FIG. 2 is a is a perspective view of a metal separator manufactured by the process of FIG. 1.

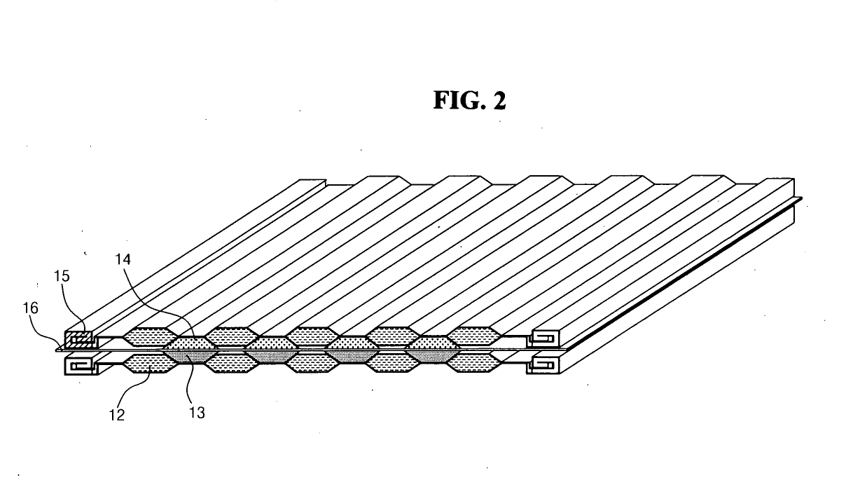

### DETAILED DESCRIPTION OF THE PREFERRED EMBODIMENTS

Hereinafter, preferred embodiments of the present invention will be described with reference to the accompanying drawings. The preferred embodiments are provided so that those skilled in the art can sufficiently understand the present invention, but can be modified in various forms and the scope of the present invention is not limited to the preferred embodiments.

A method of molding a metal separator in accordance with an embodiment of the present invention includes cutting two plates; bending the resulting plates using a press machine (mold) to have concave and convex portions; and placing a first of the plates, 10, on top of a second of the plates, 11, such that the concave portions of each plate face the convex portions of the other plate.

In more detail, each plate 10, 11 includes zigzag concave and convex portions, such as the trapezoidal zigzags shown. The second plate 11 is flipped 180 degrees to match the first plate 10. The two plates 10 and 11 are then connected, forming hexagonal coolant flow paths 12. A hydrogen flow path 13 of the first plate 10 and an oxygen flow path 14 of the second plate 11 are further established between the coolant flow paths 12.

A pair of separators, each formed of one first plate 10 and one second plate 11, are stacked by interposing an MEA 16 therebetween. Oxygen is supplied to an oxygen electrode on the upper part of the MEA 16, and hydrogen is supplied to a hydrogen electrode on the lower part of the MEA 16.

In order to maintain airtightness of the separator, a sealant 15 is inserted between both ends of the plates 10 and 11.

Since a seaming process, described below, includes several bends, and in order to prevent the sealant 15 from escaping, the first and second plates 10 and 11 are placed so that the ends of the second plate 11 protrude beyond the ends of the first plate 10, before performing the seaming processes.

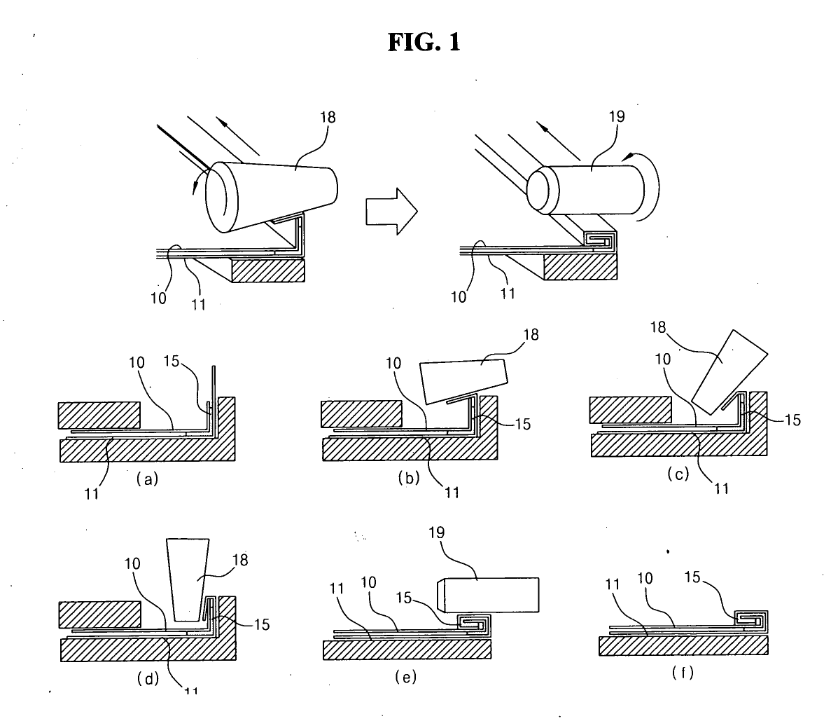

After this placement, each end of the plates 10 and 11 is bent 90° upward, and then the ends of the second plate 11 are bent inward, up to the ends of the first plate 10, as seen in portions a-d of FIG. 1.

A roller 18 used for this bending operation is conical, and, as seen the the upper left portion of FIG. 1, is simultaneously rotated and moved longitudinally to bend the first and second plates 10 and 11.

Subsequently, the end portion of the second plate 11 overlaps the inside of the first plate 10 and, then, if the end portion of the separator in a [symbol] shape is bent again, the end portion of the separator has a [symbol] c shape, thus completing the seaming process.

A roller 19 used in the this bending operation is cylindrical, and, as seen in the upper right portion of FIG. 1, is simultaneously rotated and moved longitudinally.

The sealant 15 is inserted automatically, and the separator is completed by bonding the first plate 10 and the second plate 11 through the seaming process.

The separators are stacked with an MEA 16 interposed between the separators and bonded therein. A rubber seal 17 is inserted between both end portions of the separator bonded by the seaming process and the MEA 16.

As described above, the inventive method has advantages in that it is possible to maintain airtightness, facilitate the stacking process to increase the rigidity of the separator, enable automation, and facilitate mass production.

While preferred embodiments of the present invention have been described and illustrated, the present invention is not limited thereto. On the contrary, it should be understood that various modifications and variations of the present invention can be made by those skilled in the art without departing from the spirit and the technical scope of the present invention as defined by the appended claims.

What is claimed is:

1. A method of manufacturing a metal separator for a fuel cell, comprising:
molding first and second plates such that each plate has at least one concave portion and at least one convex portion;
applying a sealant to at least one of the plates;
placing the plates such that concave portion of the first plate is opposite the convex portion of the second plate, and the convex portion of the first plate is opposite the concave portion of the second plate; and
seaming a first end of the first plate to a first end of the second plate, and a second end of the first plate to a second end of the second plate.

2. The method of claim 1, wherein the placing further comprises placing the first end of the second plate to protrude beyond the first end of the first plate, and the second end of the second plate to protrude beyond the second end of the first plate.

3. The method of claim 2, wherein the seaming comprises:
(a) bending each end of the plates at a substantially right angle;
(b) bending each end of the second plate to substantially surround a respective end of the first plate; and
(c) bending each end of the plates at an additional substantially right angle.

4. The method of claim 3, wherein steps (a) and (b) comprise bending with a substantially conical roller, and step (c) comprises bending with a substantially cylindrical roller.
